(19) United States
(12) Patent Application Publication
(10) Pub. No.: US 2005/0138431 A1
(43) Pub. Date: Jun. 23, 2005

(54) Network protection software and method

(76) Inventor: Jay P. Harrison, Walled Lake, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 11/021,621

(22) Filed: Dec. 23, 2004

Related U.S. Application Data
(60) Provisional application No. 60/532,079, filed on Dec. 23, 2003.

(51) Int. Cl. H04L 9/00

(52) U.S. Cl. 713/201

(57) ABSTRACT

A software-based system allows immediate isolation of all IP traffic until a newly added machine has been qualified. In the preferred embodiment, this verification is carried out using a variety of mechanisms, optionally including a local agent, vulnerability scanning, and system fingerprinting. Any newly attached machine requesting an IP address is quarantined into a restricted address space until an authorization server validates that it is running a valid operating system at the appropriate patch levels, is not actively scanning or transmitting malicious data, has the proper virus software and engine, and is not vulnerable on known Trojan ports.

### REFERENCE TO RELATED APPLICATION

This application claims priority from U.S. Provisional Patent Application Ser. No. 60/532,079, filed Dec. 23, 2003, the entire content of which is incorporated herein by reference.

### FIELD OF THE INVENTION

This invention relates generally to computer networking and, in particular, to software and methods for isolating a newly connected machine until certain criteria are met.

### BACKGROUND OF THE INVENTION

Network security is becoming increasingly critical, since without adequate protection unauthorized users can access private files and disrupt applications. In contrast to previous dial-up connections, the widespread use of broadband connections has resulted in users being continually susceptible to intrusion and attacks. Weaknesses in operating systems and network protocols have also led to increased denial-of-service problems.

A present, most computer network security is provided through application programs such as firewalls, anti-virus and spyware/adware removal packages. Such systems are designed to prevent and remove unwanted programs contracted through the Internet or other network connections using email or browsers, for example. Even so, malware can nevertheless be loaded from hackers intentionally sending information specifically to that user or host computer.

Unfortunately, an outstanding need for enhanced network security will probably always be necessary.

### SUMMARY OF THE INVENTION

This invention resides in a software-based system that allows immediate isolation of all IP traffic until a newly added machine has been qualified. In the preferred embodiment, this verification is carried out using a variety of mechanisms, optionally including a local agent, vulnerability scanning, and system fingerprinting.

According to the invention, any newly attached machine requesting an IP address is quarantined into a restricted address space until an authorization server validates that it is running a valid operating system at the appropriate patch levels, is not actively scanning or transmitting malicious data, has the proper virus software and engine, and is not vulnerable on known Trojan ports.

Thus, the invention performs system vulnerability scanning and fingerprinting using tools for automatically updating system and application software in a quarantined environment prior to granting a valid IP. The preferred embodiment includes a Dynamic Host Configuration Protocol (DHCP) administrator, validate/scan/update system, and optionally a client agent, all software-based.

### BRIEF DESCRIPTION OF THE DRAWING

FIG. 1 is a diagram illustrating the preferred embodiment of the invention.

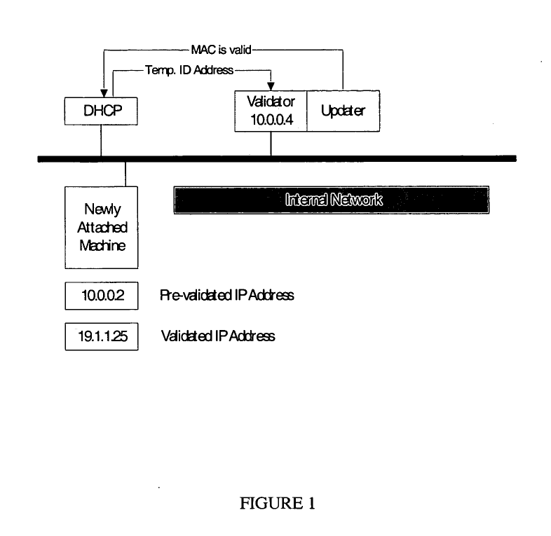

### DETAILED DESCRIPTION OF THE INVENTION

Making reference to the Figure, any machine being added to the network is initially assigned a temporary Internet Protocol (IP) address which will be restricted to a limited number of one or more machines (i.e., the Validater, Scanner, and Updater). Once assigned this temporary IP, the system notifies the Validater, which in turn scans for vulnerability, and detects the need for any updates, and applies them according to established practices within a particular organization. Once the Validater/Updater is completed, it allows the system to receive a valid IP.

A Dynamic Host Configuration Protocol (DHCP) Administrator is responsible for receiving an initial DHCP request from a newly added client machine. The DHCP Administrator then supplies a temporary IP restricted using a full netmask (FF.FF.FF.FFh) which will allow the client to connect on IP layer 3 only to the designated Validation/Scanning/Updating (V/S/U) system.

The V/S/U will then either; (a) communicate with a client agent running on the machine to determine O/S levels, patch levels, and antivirus compliance, or (b) employ system fingerprinting technology to determine the same. The V/S/U can then initiate Trojan and MalWare vulnerability scans on the identified system. Upon validation, and optional upgrading of client system software, the V/S/U will provide a valid IP address with appropriate access to the network.

The approach provides numerous benefits. First, integration is seamless from a user standpoint. User machines are insulated from the network until validated, and no additional hardware or physical network reconfiguration is required. The solution is low in cost, highly scaleable without linear cost increases or hardware, and more secure than existing systems. It is hardware independent, uses existing infrastructures, and handles non-agent devices.

1. A network protection method, comprising the steps of:
assigning a temporary IP address to a machine added to a network;
verifying that the machine meets certain criteria; and, if it does, assigning the machine a non-temporary IP address.

2. The method of claim 1, wherein the step of verifying that the machine meets certain criteria includes vulnerability scanning.

3. The method of claim 1, wherein the step of verifying that the machine meets certain criteria includes system fingerprinting.

3. The method of claim 1, wherein the step of verifying that the machine meets certain criteria includes verifying that the machine is using a valid operating system at the appropriate patch levels.

4. The method of claim 1, wherein all IP traffic is isolated until the machine is verified.

5. The method of claim 1, wherein the verification is accomplished using a local agent.

6. A system for protecting a network against a newly added machine, comprising:
a Dynamic Host Configuration Protocol (DHCP) administrator operative to perform the following functions:
assign a temporary IP address to a machine added to a network;
verify that the machine meets certain criteria; and, if it does, assign the machine a non-temporary IP address.

7. The system of claim 6, wherein the DHCP is operative to perform vulnerability scanning on the new machine.

8. The system of claim 6, wherein the DHCP is operative to fingerprint the new machine.

9. The system of claim 6, wherein the DHCP is operative to verify that the machine meets certain criteria includes verifying that the machine is using a valid operating system at the appropriate patch levels.

10. The system of claim 6, wherein all IP traffic is isolated until the machine is verified.

11. The system of claim 6, further including a local agent.
